(19) United States
(12) Patent Application Publication
(10) Pub. No.: US 2016/0125508 A1
(43) Pub. Date: May 5, 2016

(54) Methods And Systems For Adding Items To Existing Orders

(71) Applicant: Wal-Mart Stores, Inc., Bentonville, AR (US)

(72) Inventors: David Jon Carr, Mountain View, CA (US); Richard Mark Ramsden, Foster City, CA (US)

(21) Appl. No.: 14/527,110

(22) Filed: Oct. 29, 2014

(51) Int. Cl. G06Q 30/06

(52) U.S. Cl. CPC G06Q 30/0635; G06Q 30/0631

(57) ABSTRACT

Various examples of methods and systems for allowing placement of additional order before pickup of a pre-existing online order are described. In one implementation, a method may receive a first order placed by a user to purchase at least a first item and an indication of a first time as an estimated time for pickup of the first order. The method may also receive at a second time a confirmation by the user that confirms pickup of the first order at approximately the estimated time for pickup. The method may further provide a selection of one or more items for the user to purchase in addition to the first order. The quantity and variety of the one or more items of the selection may be based at least in part on a duration between the second time and the first time.

### TECHNICAL FIELD

The present disclosure relates to methods and systems for adding items to existing orders.

### BACKGROUND

With the increasing trend of online shopping, a brick-and-mortar merchant that operates a number of physical stores to sell products and services may also utilize the Internet as an additional avenue to sell the products and services. For example, in addition to its existing physical stores, a merchant may also operate an electronic commerce (e-commerce) website through which consumers can purchase one or more of the products and services offered by the merchant.

In some cases, a consumer may place an online order for a product or service via the website of the merchant, and the consumer will visit one of the physical stores of the merchant to either pick up the product or receive the service that was purchased online. Before actually picking up the online order, for one reason or another, the consumer may realize or otherwise determine that there may be one or more additional items not included in the online order. Accordingly, during the pickup of the online order, the consumer may need to spend additional time at the physical store to find and purchase the one or more additional items. Spending the additional time at the store, however, may not be desirable and may somewhat defeat the original purpose of placing the online order.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a diagram depicting an example computing environment in which example embodiments may be implemented.

FIG. 2 is a block diagram depicting an embodiment of a transaction server configured to add new items to existing orders.

FIG. 3 is a flowchart diagram of an example process for adding new items to existing orders.

FIG. 4 is a flowchart diagram of another example process for adding new items to existing orders.

FIG. 5 is a flowchart diagram of yet another example process for adding new items to existing orders.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

The articles “a” and “an” are used herein to refer to one or to more than one (i.e. to at least one) of the grammatical object of the article. By way of example, “a user” means one user or more than one users. Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

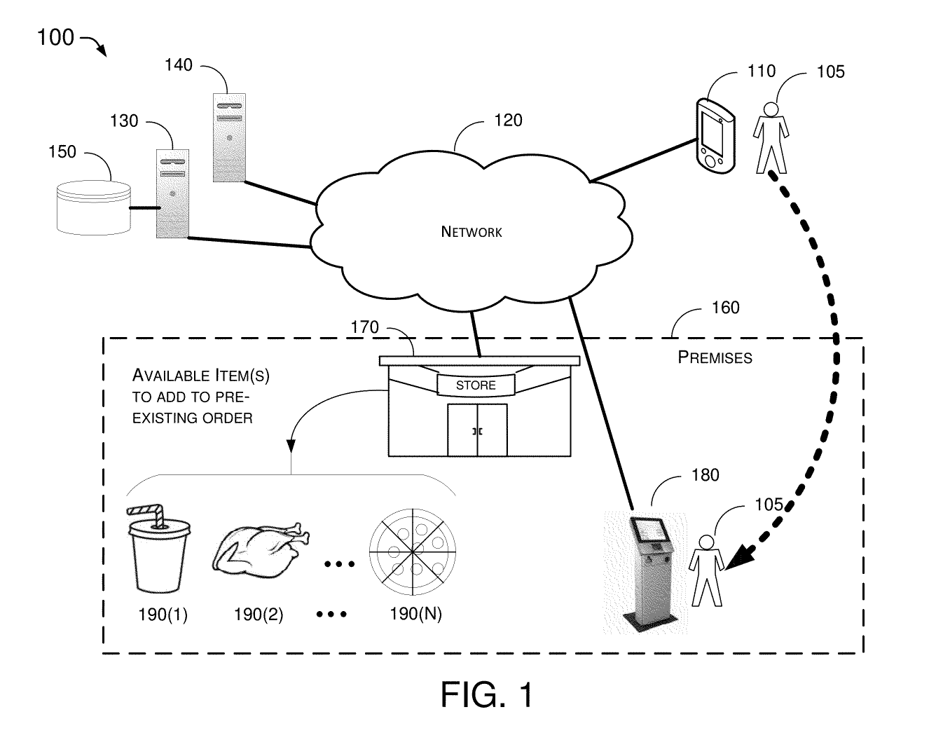

FIG. 1 is a diagram depicting an example computing environment 100 in which example embodiments of the present disclosure may be implemented. In example computing environment 100, a brick-and-mortar merchant that operates a number of physical stores (including a physical store 170) to sell products and services may also allow online shopping of its products and services by online shoppers (herein interchangeably referred to as users), e.g., a user 105 using a user device 110, at an e-commerce website hosted on a web server 140 via a network 120. Example computing environment 100 may also include a transaction server 130 in which embodiments of the present disclosure are implemented. That is, transaction server 130 may be configured to allow users, e.g., user 105, to place a new order of one or more items in addition to a pre-existing online order before picking up the online order at a physical store, e.g., physical store 170. For example, transaction server 130 may be configured to perform operations of each of example processes 300, 400 and 500 described below. Transaction server 130 may be communicatively connected to a database 150 via network 120 or a local area network. In some embodiments, database 150 may be an integral part of transaction server 130. Database 150 may record, store or otherwise contain therein data associated with a set of products and/or services that are available for sale at the e-commerce website hosted on web server 140 for pickup at one or more physical stores associated with the merchant, including physical store 170. Database 150 may also record, store or otherwise contain therein data associated with a set of products and/or services that are available for sale at physical store 170. Although one web server 140 is shown in FIG. 1, some embodiments may use multiple web servers 140 to implement an e-commerce website.

Physical store 170 may be located at a location or premises 160 operated by, rented by, owned by or otherwise associated with the merchant. As shown in FIG. 1, within premises 170 there is a kiosk 180. In some embodiments, kiosk 180 may be operated by or otherwise associated with the merchant, and may be in a close proximity of physical store 170. Physical store 170 may include one or more computing devices (not shown) that are communicatively connected to network 120. User device 110, transaction server 130, web server 140, the one or more computing devices at physical store 170 and kiosk 180 may be communicatively connected to each other via network 120.

When user 105 places an online order, e.g., via user device 110, for one or more items at the e-commerce website of the merchant, e.g., hosted on web server 140, user 105 may select physical store 170, among a plurality of physical stores associated with the merchant, as the desired store where user 105 plans to pick up the one or more items of the online order. The website may also request user 105 to enter a date and a time of the day as an estimated date/time for pickup of the one or more items of the online order.

Embodiments of the present disclosure allow users to add new orders to pre-existing online orders in at least two ways: (1) when users confirm their estimated time of arrival at the physical store for pickup of the online order, and (2) when users arrive at a location proximate the physical store. In the first scenario, at a certain period of time after the placement of the online order and before the scheduled pickup time, e.g., one hour or two hours, user 105 may confirm that he/she is indeed coming to physical store 170 at the scheduled pickup time to pick up the first order. For example, transaction server 130 may send a request to user device 110 of user 105 one hour or two hours prior to the scheduled pickup time for user 105 to either confirm the pickup of the online order at physical store 170 at the scheduled time or indicate a new date and time as a re-scheduled pickup date/time. This request may be sent in the form of a text message or an electronic mail. Alternatively, user 105 may have installed on user device 110 an app associated with the merchant, and transaction server 130 may send a signal to the app to trigger the app to prompt user 105 to confirm or reschedule via user device 110 by entering a confirmation or a new pickup date/time, which is sent back to transaction server 130 by the app. Still alternatively, user 105 may log in to the website associated with the merchant, e.g., the same website at which user 105 placed the online order, for confirmation or rescheduling.

If user 105 confirms the pickup of the online order at physical store 170 at the scheduled time, user 105 may be presented a selection of one or more items that are available at physical store 170 which user 105 may add to the online order and pick up when picking up the online order. For example, transaction server 130 may access database 150 to determine availability of a plurality of items at current time at physical store 170. Transaction server 130 may, in view of a duration between the time of the confirmation and the scheduled pickup time as well as in view of the respective preparation time for each item available at physical store 170 for the item to be ready for delivery to/pickup by user 105, determine that one or more items at physical store 170 are eligible for purchase by user 105 as a new order in addition to the pre-existing online order. For example, transaction server 130 may identify a plurality of items, e.g., items 190(1), 190(2), . . . , 190(N), that are available at physical store 170 and eligible for order and pickup by user 105, given the relatively short amount of time required to prepare each of the items 190(1), 190(2), . . . , 190(N) to make the item ready for pickup. Items 190(1), 190(2), . . . , 190(N) may include pizza, roasted chicken, soft drinks, etc. That is, items 190(1), 190(2), . . . , 190(N) may include one or more hot items. Transaction server 130 may present the selection of the one or more items to user 105. The selection of the one or more items may be presented to user 105 in an email, by the app on user device 110, or at the website associated with the merchant, depending on how user 105 confirms the pickup of the online order.

In the second scenario, at a certain period of time after the placement of the online order and when user 105 visits premises 160 to pick up the online order, user 105 may first check in at kiosk 180 to notify staff of physical store 170 of the arrival of user 105. The notification regarding the arrival of user 105 may be sent by kiosk 180 to transaction server 130. The notification regarding the arrival of user 105 may also be sent by kiosk 180 to one or more computing devices of physical store 170, so that staff at physical store 170 may be informed and can start collecting and bagging/packing item(s) of the online order to deliver to user 105. By checking in at kiosk 180, user 105 effectively confirms the pickup of the online order at the time of the check-in. As with the first scenario, in the second scenario user 105 may be presented a selection of one or more items that are available at physical store 170 which user 105 may add to the online order and pick up when picking up the online order. Similarly, transaction server 130 may access database 150 to determine availability of a plurality of items at current time at physical store 170 and, in view of the respective preparation time for each item available at physical store 170 for the item to be ready for delivery to/pickup by user 105, determine that one or more items at physical store 170 are eligible for purchase by user 105 as a new order in addition to the pre-existing online order. Transaction server 130 may present the selection of the one or more items to user 105 via kiosk 180, e.g., visually via a display panel of kiosk 180 and/or audibly via one or more speakers of kiosk 180. In some embodiments, user 105 may be given a predefined duration of time, e.g., two minutes, to decide whether or not to order at least one of the items from the selection so as to avoid user 105 taking too much time to decide and ending up having to wait longer than expected by user 105 to pick up the online order and the newly ordered one or more items.

As a result of presenting the selection of one or more items to user 105, transaction server 130 may receive, whether from user device 110, the website associated with the merchant, or kiosk 180, an indication of at least one item from the selection of one or more items that user 105 desires to add, as a new order, to the pre-existing online order to be picked up at the same time at physical store 170. In some embodiments, transaction server 170 may process the new order and the pre-existing order as two separate transactions. Alternatively, transaction server 170 may process the new order and the pre-existing order as a single transaction.

Advantageously, the ability to allow users who have placed online orders to add new orders to the pre-existing online orders may save time for the users. For example, when user 105 is given the opportunity to purchase one or more items in addition to the pre-existing online order, user 105 may appreciate the convenience. From the perspective of the merchant, such ability may help increase total sales revenue and improve customer satisfaction and loyalty.

User device 110 may be a mobile device such as a smartphone, a laptop computer, a notebook computer, a tablet computer, a wearable computer, a desktop computer, a personal data assistant (PDA), an internet appliance, a server or any other computing device configured with a network connection. Each of web server 140 and transaction server 130 may include one or more servers or any suitable computing device configured with a network connection. Each of transaction server 130 and web server 140 may be operated by the merchant or a respective service provider. In some embodiments, transaction server 130 and web server 140 may be implemented together in one or more servers or computing devices.

Network 120 may include wired and/or wireless networks that enable communications between the various networked devices associated with example computing environment 100, such as user device 110, transaction server 130, web server 140, one or more computing devices of physical store 170, and kiosk 180. Network 120 may include a variety of different networked devices that are of different types and families. In some embodiments, network 120 may include one or more local area networks (LANs), one or more wide area networks (WAN), one or more mobile telephone networks (MTNs), and/or other types of networks, possibly in conjunction with one another, to facilitate communication among the various networked devices of FIG. 1.

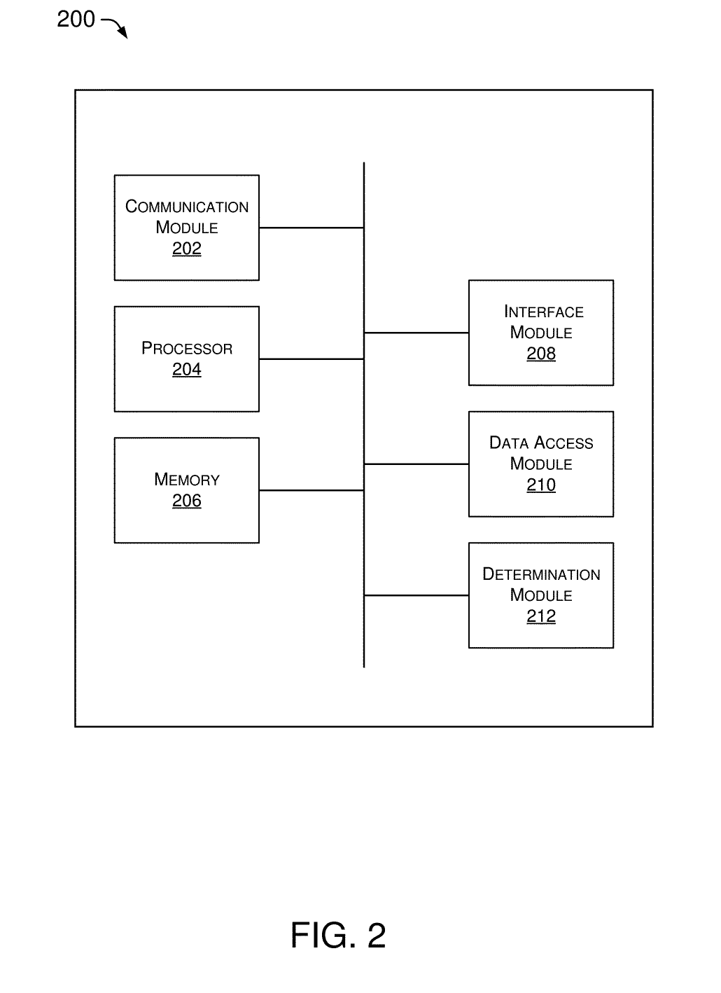

FIG. 2 is a block diagram depicting an embodiment of a transaction server 200 configured to implement example embodiments for adding new items to existing orders in accordance with the present disclosure. Transaction server 200 may perform various functions related to embodiments of the present disclosure. In some embodiments, transaction server 200 may be implemented in or as transaction server 130 of FIG. 1. In some embodiments, transaction server 200 may be implemented as one or more computing devices that cooperatively implement the functions described herein. Transaction server 200 may include a communication module 202, one or more processors (shown as a processor 204 in FIG. 2), and a memory 206. Communication module 202 may allow transaction server 200 to communicate with other networks, systems, servers, computing devices, etc. Processor 204 may execute one or more sets of instructions to implement the functionality provided by transaction server 200. Memory 206 may store the one or more sets of instructions executable by processor 204 as well as other data used by processor 204.

Transaction server 200 may also include an interface module 208, a data access module 210 and a determination module 212. Each of interface module 208, data access module 210 and determination module 212 may perform one or more functions under the control of processor 204. For example, under the control of processor 204, each of interface module 208, data access module 210 and determination module 212 may perform one or more operations of each of example processes 300, 400 and 500 described below. Although interface module 208, data access module 210 and determination module 212 are depicted in FIG. 2 as discrete modules separate from the processor 204, in various implementations one or more of interface module 208, data access module 210 and determination module 212 may be integral part of processor 204. For simplicity, a task or function performed by any of interface module 208, data access module 210 and determination module 212 may be described as if such task or function is performed by processor 204.

Interface module 208 may be configured to receive online orders for purchase of products and services that can be picked up and/or received at physical store 170. For example, interface module 208 may receive a first order placed by user 105, via user device 110 at the website associated with the merchant and hosted on web server 140, to purchase at least a first item. Interface module 208 may also receive an indication of a first time as an estimated time for pickup of the first order at physical store 170. Interface module 208 may also be configured to receive at a second time a confirmation by the user that confirms pickup of the first order at approximately the estimated time for pickup. For example, interface module 208 may receive an online order placed by user 105 for pickup at physical store 170 and at a scheduled date and time. At a later time, interface module 208 may send a request to user device 110 of user 105 some time, e.g., one hour or two hours, prior to the scheduled pickup time for user 105 to either confirm the pickup of the online order at physical store 170 at the scheduled time or indicate a new date and time as a re-scheduled pickup date/time. This request may be sent in the form of a text message or an electronic mail. Alternatively, interface module 208 may send a signal to an app on user device 110 to trigger the app to prompt user 105 to confirm or reschedule via user device 110 by entering a confirmation or a new pickup date/time, which is sent back to interface module 208 by the app. Still alternatively, interface module 208 may receive the confirmation or rescheduling information from user 105 via web server 140, which hosts the website associated with the merchant and through which user 105 indicates confirmation or enters information for rescheduling.

Interface module 208 may also be configured to receive a notification, e.g., from kiosk 180, regarding the arrival of user 105.

Interface module 208 may further be configured to present a selection of one or more items to user 105, e.g., via user device 110 or kiosk 180, to visually and/or audibly present the selection to user 105. In some embodiments, interface module 208 may allow user 105 a predefined duration of time, e.g., two minutes, during which user 105 may decide whether or not to order at least one of the items from the selection.

Data access module 210 may be configured to access a database, e.g., database 150, to obtain information and/or data associated with items available for sale online or at one or more physical stores, e.g., physical store 170. For example, data access module 210 may access database 150 to determine availability of a plurality of items at current time at physical store 170.

Determination module 212 may be configured to determine, based on data obtained by data access module 210 from database 150, the availability of a plurality of items at current time at physical store 170. For example, determination module 212 may, in view of: (1) a duration between the time of the confirmation and the scheduled pickup time and/or (2) the respective preparation time for each item available at physical store 170 for the item to be ready for delivery to/pickup by user 105, determine that one or more items at physical store 170 are eligible for purchase by user 105 as a new order in addition to the pre-existing online order. That is, the quantity and variety of the one or more items in the determined selection may be based at least in part on either or both of the above-listed factors.

In some embodiments, the one or more items in the selection may include one or more items having a preparation time for pickup no greater than a threshold duration of time or the duration between the second time and the first time. For example, if use 105 confirms that the online order will be picked up at the scheduled time and that the preparation time of any of items 190(1), 190(2), . . . , 190(N) is no greater than a duration of time between the time the confirmation is received and the scheduled pickup time, then such item(s) may be an item in the selection. Alternatively, if the preparation time of any of items 190(1), 190(2), . . . , 190(N) is no greater than a threshold duration of time, e.g., three minutes, then such item(s) may be an item in the selection.

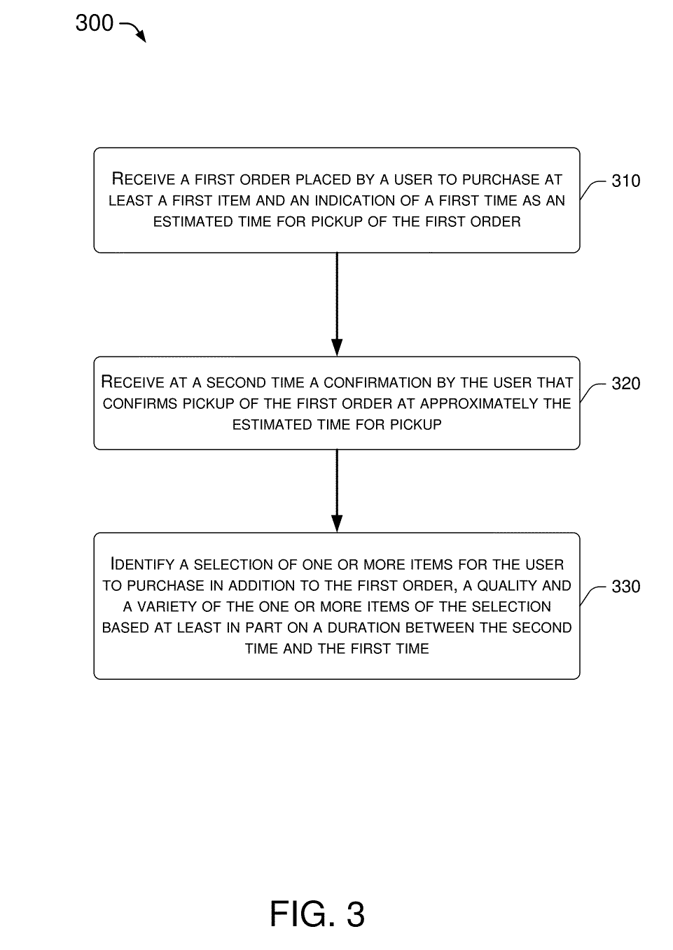

FIG. 3 is a flowchart diagram of an example process 300 related to combining an online order with additional items purchased by a user during pickup of the online order in accordance with an embodiment of the present disclosure. Example process 300 may include one or more operations, actions, or functions such as 310, 320 and 330. Although illustrated as discrete blocks, various blocks may be divided into additional blocks, combined into fewer blocks, or eliminated, depending on the desired implementation. Example process 300 may be implemented by one or more processors including, for example, one or more processors of transaction server 130 and/or transaction server 200. For illustrative purposes, the operations described below are performed by one or more processors of transaction server 130 and/or processor 204 of transaction server 200. Each of transaction server 130 and transaction server 200 may be referred to as a computing device herein.

At 310, one or more processors of transaction server 130 or transaction server 200 may receive a first order placed by a user to purchase at least a first item and an indication of a first time as an estimated time for pickup of the first order.

At 320, the one or more processors of transaction server 130 or transaction server 200 may receive at a second time a confirmation by the user that confirms pickup of the first order at approximately the estimated time for pickup.

At 330, the one or more processors of transaction server 130 or transaction server 200 may identify a selection of one or more items for the user to purchase in addition to the first order. A quantity and a variety of the one or more items of the selection may be based at least in part on a duration between the second time and the first time.

In at least some embodiments, in identifying the selection of the one or more items for the user to purchase in addition to the first order, example process 300 may involve the one or more processors of transaction server 130 or transaction server 200 determining the one or more items from a plurality of items available for sale at a physical store for the pickup of the first order based at least in part on the duration between the second time and the first time.

In at least some embodiments, the one or more items may include one or more items having a preparation time for pickup no greater than the duration between the second time and the first time.

In at least some embodiments, in receiving the first order, example process 300 may involve the one or more processors of transaction server 130 or transaction server 200 receiving the first order from a website associated with a merchant.

In at least some embodiments, in receiving the confirmation, example process 300 may involve the one or more processors of transaction server 130 or transaction server 200 receiving the confirmation at a kiosk associated with a merchant.

In at least some embodiments, example process 300 may also involve the one or more processors of transaction server 130 or transaction server 200 sending a request to the user to confirm whether the user will pick up the first order at approximately the first time.

In at least some embodiments, example process 300 may also involve the one or more processors of transaction server 130 or transaction server 200 receiving a second order placed by the user to purchase at least a second item of the one or more items in response to providing the selection. Example process 300 may further involve the one or more processors of transaction server 130 or transaction server 200 processing the first order and the second order as a single transaction.

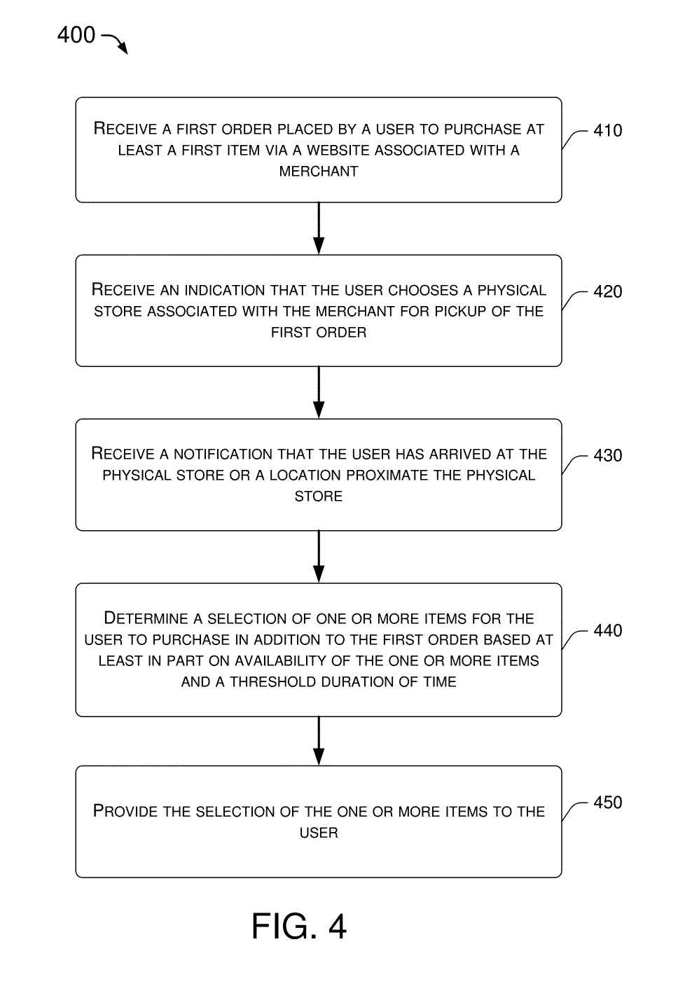

FIG. 4 is a flowchart diagram of an example process related to combining an online order with additional items purchased by a user during pickup of the online order in accordance with another embodiment of the present disclosure. Example process 400 may include one or more operations, actions, or functions such as 410, 420, 430, 440 and 450. Although illustrated as discrete blocks, various blocks may be divided into additional blocks, combined into fewer blocks, or eliminated, depending on the desired implementation. Example process 400 may be implemented by one or more processors including, for example, one or more processors of transaction server 130 and/or transaction server 200. For illustrative purposes, the operations described below are performed by one or more processors of transaction server 130 and/or processor 204 of transaction server 200. Each of transaction server 130 and transaction server 200 may be referred to as a computing device herein.

At 410, one or more processors of transaction server 130 or transaction server 200 may receive a first order placed by a user to purchase at least a first item via a website associated with a merchant.

At 420, the one or more processors of transaction server 130 or transaction server 200 may receive an indication of a physical store associated with the merchant for pickup of the first order.

At 430, the one or more processors of transaction server 130 or transaction server 200 may receive a notification that the user has arrived at the physical store or a location proximate the physical store.

At 440, the one or more processors of transaction server 130 or transaction server 200 may determine a selection of one or more items for the user to purchase in addition to the first order, a quantity of a variety of the one or more items based at least in part on availability of the one or more items and a threshold duration of time

At 450, the one or more processors of transaction server 130 or transaction server 200 may provide the selection of the one or more items to the user.

In least some embodiments, the one or more items may include one or more items having a preparation time for pickup no greater than the threshold duration of time.

In least some embodiments, in receiving the notification, example process 400 may involve the one or more processors of transaction server 130 or transaction server 200 receiving the notification via a kiosk proximate the physical store.

In least some embodiments, in providing the selection of the one or more items to the user, example process 400 may involve the one or more processors of transaction server 130 or transaction server 200 allowing the user to select at least an item from the selection of the one or more items within a predefined duration of time.

In least some embodiments, example process 400 may also involve the one or more processors of transaction server 130 or transaction server 200 sending a request to the user to confirm whether the user will pick up the first order at approximately the first time.

In least some embodiments, example process 400 may also involve the one or more processors of transaction server 130 or transaction server 200 receiving a second order placed by the user to purchase at least a second item of the one or more items in response to providing the selection.

In least some embodiments, example process 400 may further involve the one or more processors of transaction server 130 or transaction server 200 processing the first order and the second order as a single transaction.

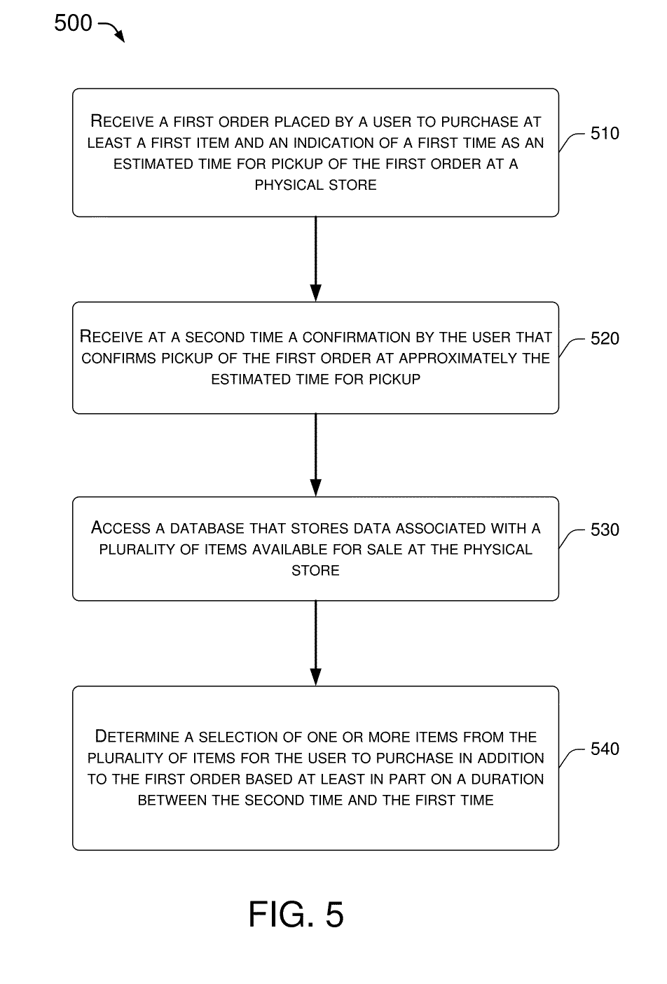

FIG. 5 is a flowchart diagram of an example process related to combining an online order with additional items purchased by a user during pickup of the online order in accordance with yet another embodiment of the present disclosure. Example process 500 may include one or more operations, actions, or functions such as 510, 520, 530 and 540. Although illustrated as discrete blocks, various blocks may be divided into additional blocks, combined into fewer blocks, or eliminated, depending on the desired implementation. Example process 500 may be implemented by one or more processors including, for example, one or more processors of transaction server 130 and/or transaction server 200. For illustrative purposes, the operations described below are performed by one or more processors of transaction server 130 and/or processor 204 of transaction server 200. Each of transaction server 130 and transaction server 200 may be referred to as a computing device herein.

At 510, one or more processors of transaction server 130 or transaction server 200 may receive a first order placed by a user to purchase at least a first item and an indication of a first time as an estimated time for pickup of the first order at a physical store.

At 520, the one or more processors of transaction server 130 or transaction server 200 may receive at a second time a confirmation by the user that confirms pickup of the first order at approximately the estimated time for pickup.

At 530, the one or more processors of transaction server 130 or transaction server 200 may access a database that stores data associated with a plurality of items available for sale at the physical store.

At 540, the one or more processors of transaction server 130 or transaction server 200 may determine a selection of one or more items from the plurality of items for the user to purchase in addition to the first order. A quantity and a variety of the one or more items of the selection may be based at least in part on a threshold duration or a duration between the second time and the first time.

In at least some embodiments, the one or more items may include one or more items having a preparation time for pickup no greater than the threshold duration or the duration between the second time and the first time.

In at least some embodiments, the first order may be received from a website associated with a merchant, and the confirmation may be received from a kiosk associated with the merchant.

In at least some embodiments, the one or more processors of transaction server 130 or transaction server 200 may also provide the selection to the user.

In at least some embodiments, the one or more processors of transaction server 130 or transaction server 200 may also receive a second order placed by the user to purchase at least a second item of the one or more items in response to providing the selection.

In at least some embodiments, the one or more processors of transaction server 130 or transaction server 200 may also process the first order and the second order as a single transaction.

Although the present disclosure is described in terms of certain embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method, comprising:
receiving, by one or more processors of a computing device, a first order placed by a user to purchase at least a first item and an indication of a first time as an estimated time for pickup of the first order;
receiving, by the one or more processors, at a second time a confirmation that the user will pickup of the first order at approximately the estimated time for pickup; and
identifying, by the one or more processors, a selection of one or more items for the user to purchase in addition to the first order, a quantity and a variety of the one or more items of the selection based at least in part on a duration between the second time and the first time.

2. The method of claim 1, wherein the identifying the selection of the one or more items for the user to purchase in addition to the first order comprises determining the one or more items from a plurality of items available for sale at a physical store for the pickup of the first order based at least in part on the duration between the second time and the first time.

3. The method of claim 1, wherein the one or more items comprise one or more items having a preparation time for pickup no greater than the duration between the second time and the first time.

4. The method of claim 1, wherein the receiving the first order comprises receiving the first order from a website associated with a merchant.

5. The method of claim 1, wherein the receiving the confirmation comprises receiving the confirmation at a kiosk associated with a merchant.

6. The method of claim 1, further comprising:
sending, by the one or more processors, a request to the user to confirm whether the user will pick up the first order at approximately the first time.

7. The method of claim 1, further comprising:
receiving, by the one or more processors, a second order placed by the user to purchase at least a second item of the one or more items in response to providing the selection; and
processing the first order and the second order as a single transaction.

8. One or more computer-readable media storing a computer-executable instruction that, when executed by one or more processors, causes the one or more processors to perform operations comprising:
receiving a first order placed by a user to purchase at least a first item via a website associated with a merchant;
receiving an indication of a physical store associated with the merchant for pickup of the first order;
receiving a notification that the user has arrived at the physical store or a location proximate the physical store;
determining a selection of one or more items for the user to purchase in addition to the first order, a quantity of a variety of the one or more items based at least in part on availability of the one or more items and a threshold duration of time; and
providing the selection of the one or more items to the user.

9. The one or more computer-readable media of claim 8, wherein the one or more items comprise one or more items having a preparation time for pickup no greater than the threshold duration of time.

10. The one or more computer-readable media of claim 8, wherein the receiving the notification comprises receiving the notification via a kiosk proximate the physical store.

11. The one or more computer-readable media of claim 8, wherein the providing the selection of the one or more items to the user comprises allowing the user to select at least an item from the selection of the one or more items within a predefined duration of time.

12. The one or more computer-readable media of claim 8, further comprising:
sending a request to the user to confirm whether the user will pick up the first order at approximately a first time.

13. The one or more computer-readable media of claim 8, further comprising:
receiving a second order placed by the user to purchase at least a second item of the one or more items in response to providing the selection.

14. The one or more computer-readable media of claim 13, further comprising:
processing the first order and the second order as a single transaction.

15. An apparatus, comprising:
a memory configured to store one or more sets of instructions;
a processor configured to access the memory to execute the one or more sets of instructions to perform operations comprising:
receiving a first order placed by a user to purchase at least a first item and an indication of a first time as an estimated time for pickup of the first order at a physical store;
receiving at a second time a confirmation by the user that confirms pickup of the first order at approximately the estimated time for pickup;
accessing a database that stores data associated with a plurality of items available for sale at the physical store; and
determining a selection of one or more items from the plurality of items for the user to purchase in addition to the first order, a quantity and a variety of the one or more items of the selection based at least in part on a threshold duration or a duration between the second time and the first time.

16. The apparatus of claim 15, wherein the one or more items comprise one or more items having a preparation time for pickup no greater than the threshold duration or the duration between the second time and the first time.

17. The apparatus of claim 15, wherein the first order is received from a website associated with a merchant, and wherein the confirmation is received from a kiosk associated with the merchant.

18. The apparatus of claim 15, wherein the processor is further configured to provide the selection to the user.

19. The apparatus of claim 15, wherein the processor is further configured to receive a second order placed by the user to purchase at least a second item of the one or more items in response to providing the selection.

20. The apparatus of claim 19, wherein the processor is further configured to process the first order and the second order as a single transaction.
